(19) United States
(12) Patent Application Publication
(10) Pub. No.: US 2007/0012738 A1
(43) Pub. Date: Jan. 18, 2007

(54) Through-axle bicycle fork mounting clamp

(76) Inventor: Michael Grim, Aptos, CA (US)

Correspondence Address: John E. Menear, 1200 Capitola Road, #4, Santa Cruz, CA, 95062, US

(21) Appl. No.: 11/483,824

(22) Filed: Jul. 10, 2006

Related U.S. Application Data
(60) Provisional application No. 60/698,677, filed on Jul. 12, 2005.

(51) Int. Cl. B60R 9/048; B60R 9/00

(52) U.S. Cl. 224/324; 224/924

(57) ABSTRACT

A bicycle mounting clamp used to transport through-axle bicycles on a vehicle rack in the fork mounted position. The clamp permits fork mounting of bicycles that do not have slots in the front fork tips. Bicycles with axle diameters equal to or larger than nine millimeters are particularly compatible with this clamp. Simplicity and ease-of-use are targeted features. Several mechanical advantages minimize the strength necessary to utilize the clamp. The method of use, which is specific to this clamp, allows axle removal and installation to be performed at ground level.

### CROSS-REFERENCE TO RELATED APPLICATION

This application claims priority to U.S. Provisional Application No. 60/698,677 entitled “Performance Bicycle Fork Mounting Clamp” filed Jul. 12, 2005.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to vehicle racks, which are used to transport bicycles in a fork mounted mode. It also related to bicycle storage racks. In particular, the instant invention addresses the transport of through-axle bicycles, which employ large diameter axles and through-axle fork tips. Note that a through-axle bicycle defines a style of bicycle, wherein the axles fit through holes (not slots) in the forks. This invention uses an axle clamp, which provides both stability and ease of use.

2. Description of Related Art

Racks for carrying bicycles on cars, trucks, and sport utility vehicles are generally classified into two categories. These two categories are distinguished by the method of bicycle attachment to the rack.

Upright racks hold the bicycle in place with three connection points. The front wheel, the rear wheel, and a frame member are all connected to the vehicle rack. The user does not have to remove the front wheel from the bicycle to use an upright rack. However, stability is not optimal, frame connections can scratch paint, and the rack itself presents a high profile—even with no bicycle attached.

Fork mounted racks hold the bicycle by the front fork and the back wheel. A user has to remove the front wheel to use a fork mounted rack. In trade, stability and security are superior, no frame connection is required, the rack presents a low profile, and many users prefer the aesthetics of a fork mount. The current invention is applicable to fork mounting.

Fork mount racks are commercially available, but use is restricted. The reason is that through-axle bicycles are incompatible with the prior art commercial fork mount racks.

Existing fork mount racks are designed for bicycles with slotted tips on the front forks. In practice, a user removes the bicycle's front wheel, which leaves the slots empty. Then the slots are lowered vertically onto a horizontal shaft with the same diameter as the axle. Finally, the slots and horizontal shaft are clamped together, typically with a cam mechanism. These existing fork mount racks presuppose that the front fork has slotted tips and that the slot openings fit the horizontal shaft.

For through-axle bicycles, the front fork tips are not slotted and the axle diameter is typically much larger than the industry standard nine millimeters. Axle diameters of eighteen to thirty-two millimeters are desirable for rugged mountain terrain, downhill racing, or extreme sports. In the near future, axle diameters greater than thirty-two millimeters may also have use. The front wheel is normally attached to the fork through openings with fully closed caps.

The consequence is that existing fork mount racks cannot be used for through-axle bicycles. By default, upright mount racks are used.

An adapter is commercially offered to fulfill this expressed, but unresolved, need to use fork mounting. One side of the adapter consists of a tubular section through which the bicycle's axle is inserted. The other side of the adapter has two protruding slotted fork tips which are compatible with prior art fork mount racks.

Unfortunately, this adapter solution is not robust. For example, the adapter can rotate around the axle and come loose. In a worst-case scenario, the bicycle could fall off the vehicle. Security is also compromised because adapters do not lock the axle to the vehicle rack. Extra parts, extra cost, and difficulty-of-use further detract from employing an adapter.

A new apparatus for fork mounting is needed. The new apparatus requires a new mechanism to handle large diameter axles.

### BRIEF SUMMARY OF THE INVENTION

The present invention is a compression clamp for fork mounting of through-axle bicycles. This clamp simplifies fork mounting, and can be used with a wide range of existing vehicle racks or storage racks.

The invented clamp is capable of fitting virtually all existing vehicle racks. The screw-and-block connection to a vehicle rack can be easily put on, taken off, or repositioned to carry other sports equipment.

A wide number of vehicle racks and storage racks are available. Several car manufacturers sell their own design. Dimensions vary. In addition, there are many companies selling vehicle racks as an after-market product. So, the capability to fit the invented clamp to virtually all existing vehicle racks is an important feature. Someone who wishes to use an existing vehicle rack or storage rack with the invented clamp can do so.

In the best contemplated mode, multi-rack compatibility is achieved with a wide range screw-and-block mechanism that encloses a rack frame member. A wide range screw-and-block mechanism forms the bottom portion of the invented clamp, and connects the invented clamp to the vehicle rack. The upper portion of the invented clamp holds the bicycle.

In preparation for use, the bicycle's front wheel and axle are removed from the bicycle. Then, the axle alone is reinstalled onto the front fork. Note that this is done with the bicycle on the ground, most likely with the wheels facing upward. An installer does not have to lift or carry the weight of the bicycle during preparation.

Given that the invented clamp has been previously attached to the vehicle's bicycle rack, the next step is to place the bicycle onto the clamp. The bicycle is lifted to the clamp. The back wheel is set into the rear wheel track, and it is still free to rotate. Next the front fork, with front axle installed, is placed into the axle groove of a divided compression zone. Finally, the opposing section of the divided compression zone is engaged and locked into place. The bicycle is now safe to transport.

Three major problems of the prior art are solved by this invention.

First, slotted forks are not required. Second, axles with diameters greater than nine millimeters can be accommodated. Third, the present invention is easy to use. One person can easily secure the bicycle to the rack. Difficult operations while holding the bicycle at high elevation are eliminated.

Subtle ease-of-use factors are built into the design. For example, gravity works with, rather than against, the installer. The preparative steps of removing the front wheel and reinstalling the front axle are done on the ground. The bicycle might tip sideways, but it cannot fall downward. At most, the installer carries only the weight of the wheel.

Gravity assists even during installation of the bicycle to the clamp. When the installer gets the front axle partially into the axle groove of the divided compression zone, gravity will help center it. The unlocked rear wheel rotates slightly as the front fork drops into the axle groove. The centered axle position corresponds to the axle's lowest elevation within the axle groove. The installer experiences this as a semi-stable resting point until the clamp is closed. When used with vertically mounted storage racks, alternate clamp configurations maintain this gravity assist feature.

Another ease-of-use factor is the minimal strength required of the installer. The clamping mechanism inherently possesses a mechanical advantage because the inventive clamp embodies leverage. An installer applies a small force at a large distance from the clamping action to generate a large force at the clamping action. This is significant because the bicycle is resting on top of the transport vehicle when the clamp is closed.

Several bicycles with axle diameters equal to or greater than nine millimeters can be used with a single invented clamp, even though the axle diameters may not be the same. Substitute axles, tubes over the axle to increase axle diameter, padding inside the clamp's compression zone, set screws inside the clamp's compression zone, or equivalent modifications permit one clamp to accommodate a range of axle diameters. The shape of the divided compression zone can also be changed by an adjustable link.

The same mechanism that locks the bicycle to the clamp also serves to insure that the clamp remains locked to the vehicle rack. This feature is consistent with safety requirements.

Objects of this invention include:
(a) enable fork mounting of bicycles whose front forks are not slotted,
(b) enable fork mounting of bicycles whose front axles equal or exceed nine millimeters in diameter,
(c) enable fork mounting of different bicycles with one clamp,
(d) provide a fork mount clamping method that attaches the front axle to the bicycle before the bicycle is lifted upward toward the vehicle rack,
(e) provide a clamping apparatus that is easy to use,
(f) provide a clamping method that is practical for one person to do alone,
(g) provide a clamping method that places the bicycle in a semi-stable position during the clamping operation,
(h) provide a clamping apparatus that uses gravity to assist in centering the bicycle on the clamp,
(i) provide a clamp which possesses an inherent mechanical advantage for the user,
(j) make the clamp compatible with substantially all existing vehicle racks,
(k) secure the bicycle into the clamp and simultaneously insure the attachment integrity between the clamp and the vehicle rack with a single motion,
(l) provide a clamp that allows vertical or horizontal mounting onto storage racks.
(m) provide a mechanism that simultaneously locks the bicycle to the clamp and the clamp to the vehicle rack.

### BRIEF DESCRIPTION OF THE SEVERAL VIEWS OF THE DRAWINGS

FIG. 1 is a diagram showing slotted forks on standard bicycles.

FIG. 2 is a diagram showing the fork tips of a through-axle bicycle.

FIG. 3A is a top/right view of a through-axle bicycle fork mounting clamp in the open position without an axle included.

FIG. 3B shows a through-axle bicycle fork mounting clamp containing an adjustable link.

FIG. 4 is a left side view of the through-axle bicycle fork mounting clamp in the closed position without an axle included.

FIG. 5 is a right side view of the through-axle bicycle fork mounting clamp in the open position with an axle included.

FIG. 6 is a front view of the through-axle bicycle fork mounting clamp in the open position without an axle included.

FIG. 7 shows one embodiment of a through-axle bicycle fork mounting clamp that holds a bicycle vertically to a storage rack.

### DETAILED DESCRIPTION OF THE INVENTION

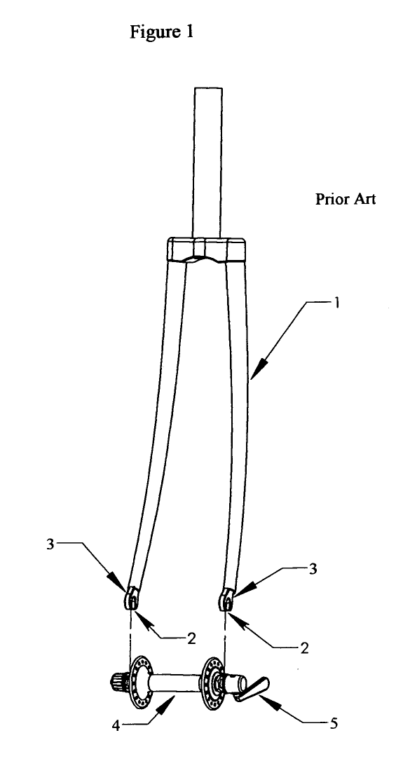

FIG. 1 shows a prior art front fork mounting system, which is used to firmly secure a standard front fork 1 to a vehicle rack. Note that the standard front fork 1 has slots 2 in each standard fork tip 3 which are lowered onto a mounting shaft 4. When the slots 2 are firmly seated onto the mounting shaft 4, a cam mechanism 5 locks the standard front fork 1 in position for transport.

The mounting shaft 4 is secured to a vehicle rack, which may have a variety of structures, depending on the manufacturer.

Note that for the prior art front fork mounting system to function, the standard front fork 1 must have slots 2 on the standard fork tips 3. Having slots 2 on the standard fork tips 3 is common for bicycles with standard nine millimeter axles.

But slotted fork tips are not used for through-axle bicycles. Part of the reason is that through-axle bicycles typically have axles with diameters larger than nine millimeters.

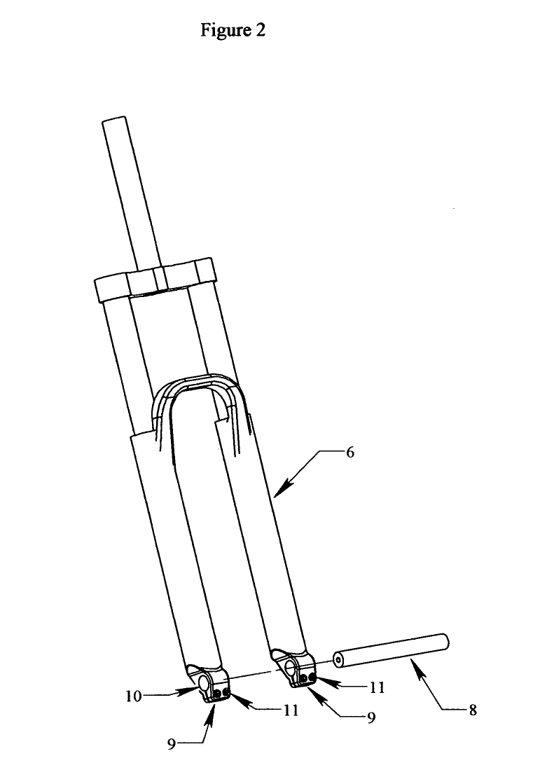

FIG. 2 shows a through-axle front fork 6 with the axle 8 removed. Note that the through-axle fork tips 9 have axle pass-through openings 10, as opposed to slots. The fork tips 9 and pinch bolts 11 form closed clamps used to hold the axle 8 onto the through-axle front fork 6.

Since prior art front fork mounting systems are not applicable to through-axle bicycles, through-axle bicycles are normally transported on upright bicycle racks. Yet, many through-axle bicyclists prefer fork mounting to upright mounting. This preference for fork mounting is evident from the sale of commercial adapters, which are insecure and difficult to use.

The present invention is a through-axle bicycle fork mounting clamp, which addresses a recognized but unresolved need.

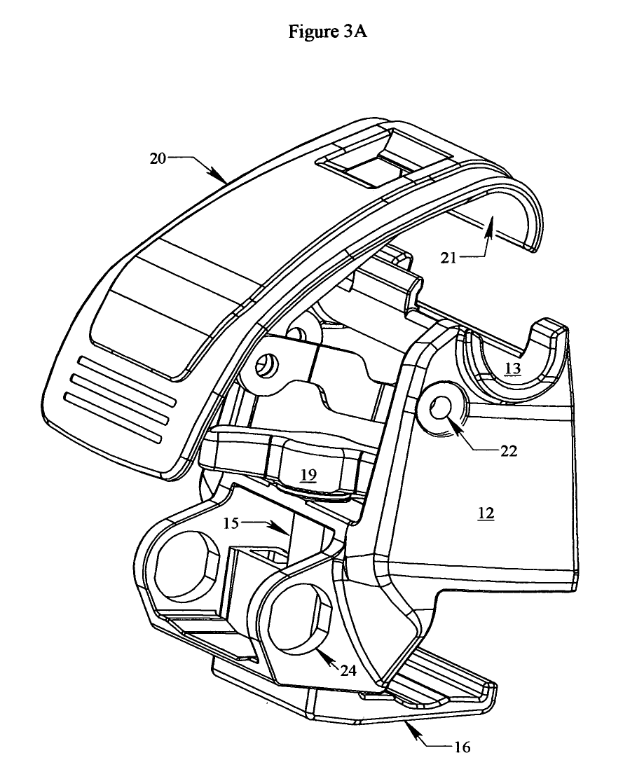

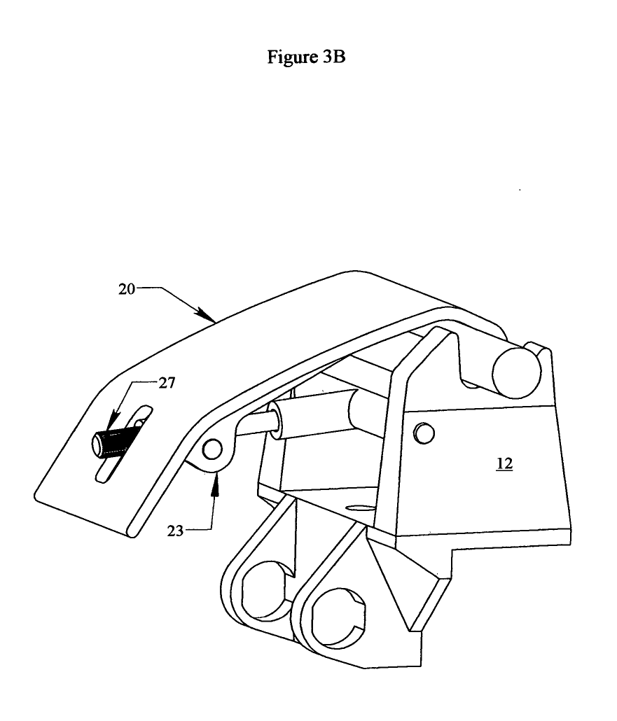

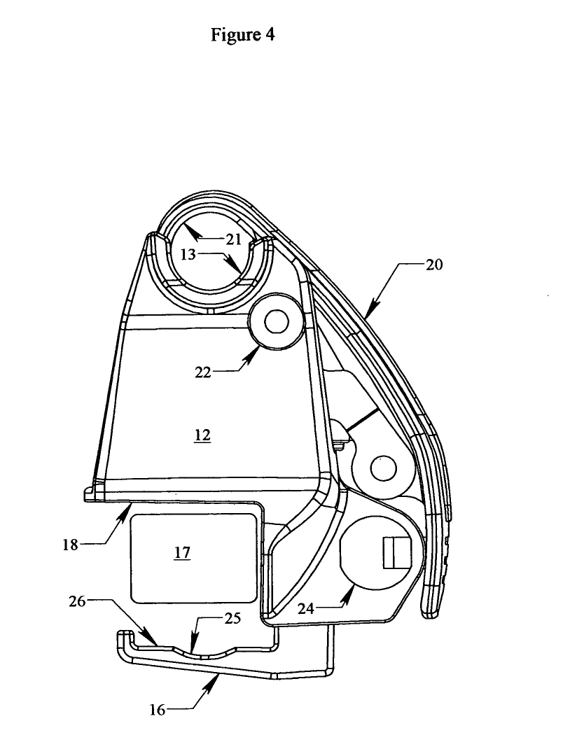

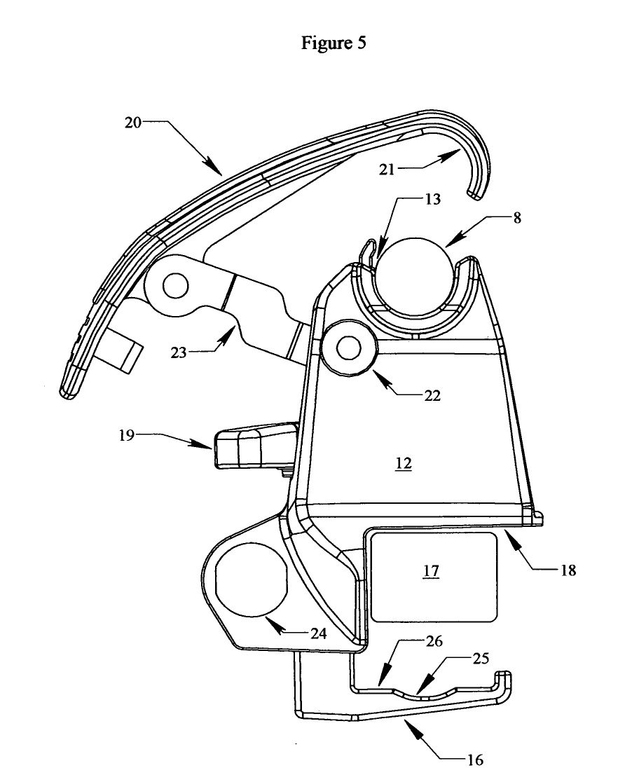

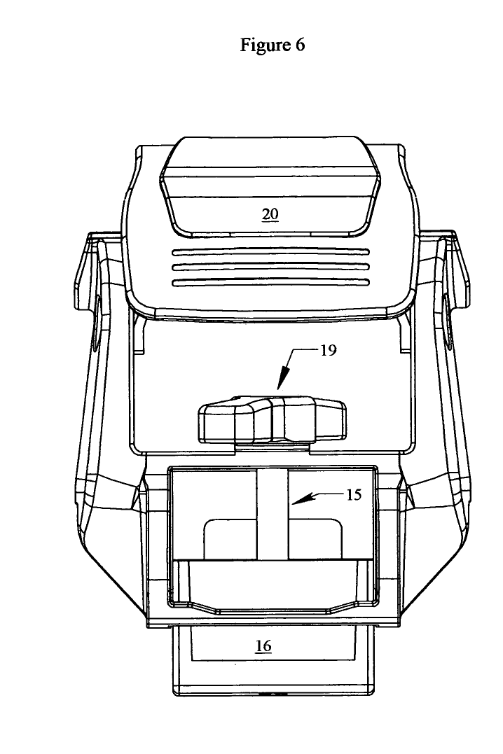

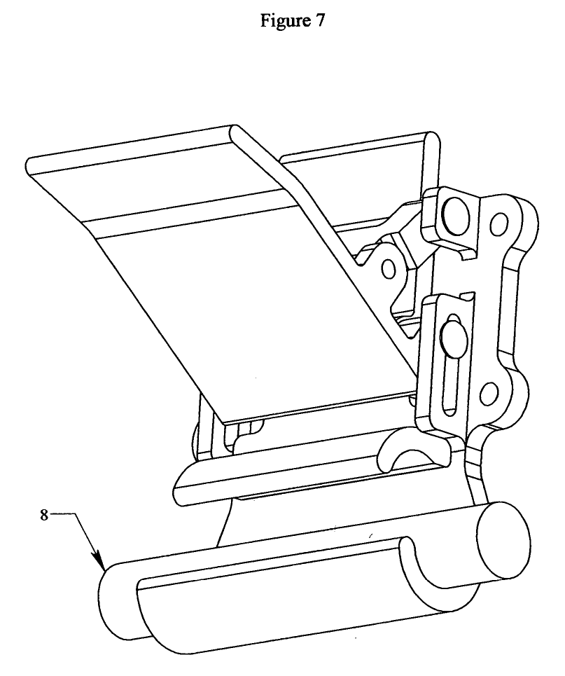

FIG. 3A, FIG. 3B, FIG. 4, FIG. 5, and FIG. 6 provide varying views of the preferred embodiment of the through-axle bicycle fork mounting clamp when used with a vehicle rack. FIG. 7 shows a modified embodiment when used with a storage rack.

In the preferred embodiment, a clamp body 12 contains a rack screw 15 which is threaded through a retaining block 16. This screw mechanism operates over a large distance range. The retaining block 16 possesses rounded surfaces 25 and straight surfaces 26, which allows a through-axle bicycle fork mounting clamp to be attached to a wide variety of vehicle racks. A structural member 17 of a vehicle rack is positioned between the retaining block 16 and the retaining ledge 18. Then the installer turns the rack screw 15 with the rack screw knob 19, which pulls the retaining block 16 closer to the retaining ledge 18. The rack screw knob 19 and rack screw 15 both impart significant mechanical advantage to the installer, and modest torque is sufficient to firmly hold the through-axle bicycle fork mounting clamp to a vehicle rack.

The through-axle bicycle fork mounting clamp can be attached to the vehicle rack by other means. For example, bolts, hinges, and cams are alternate ways (not a complete list) to connect the through-axle bicycle fork mounting clamp to the vehicle rack.

It should be noted that a bicycle rack vendor may integrate a through-axle bicycle fork mounting clamp into the bicycle rack when the bicycle rack is manufactured. In this case, the attachment could be a molded shape that is inseparable from the vehicle rack itself. Or the through-axle bicycle fork mounting clamp could be included as a separate component.

The clamp body 12 possesses a hollow axle groove 13, which is sized to hold an axle 8 of predetermined diameter. The shape of the axle groove 13 substantially corresponds to half of a cylinder, whose diameter is nearly equal to the diameter of the axle. Axle diameters of eighteen to thirty-two millimeters are used with current through-axle bicycle designs. Even axles 8 larger than thirty-two millimeters may be used with the through-axle bicycle fork mounting clamp.

In preparation for mounting a bicycle onto the through-axle bicycle fork mounting clamp, the bicycle's front wheel is removed from the through-axle front fork 6. Then the axle 8, by itself, is reinstalled onto the through-axle front fork 6.

To mount the through-axle front fork 6 of the bicycle, with the axle 8 installed, onto the through-axle bicycle fork mounting clamp, the axle 8 is set into the axle groove 13. Next, the securing handle 20 is moved to the closed position, which, in this embodiment, is closer to the clamp body 12. This creates rotational movement around the hinge 22. As the securing handle 20 approaches the closed position, the compression surface 21 pulls the axle 8 firmly into the axle groove 13 and prevents the axle 8 from escaping. In this embodiment, the compression surface 21 conforms to a semi-cylindrical shape. However, other shapes are acceptable, providing the axle 8 is firmly secured between the axle groove 13 and the compression surface 21.

Closing the securing handle 20 simultaneously performs a second function. When closed, either the link 23 or the securing handle 20 itself prevents the rack screw knob 19 from turning. This is a safety feature because the through-axle bicycle fork mounting clamp cannot accidentally separate from the vehicle rack.

In a useful improvement modification, a spring loaded button latch captures the securing handle 20 upon closing. This provides an extra margin of safety.

A lock may be placed through the anti-theft lock hole 24 to provide additional levels of security and safety.

A wide range of axle diameters is compatible with a through-axle bicycle fork mounting clamp. There are two ways to accommodate varying axle diameters. The first is to include a link adjustment 27 to the link 23 or multiple links. In FIG. 3B, the link adjustment 27 comprises a screw mechanism that protrudes through a slot in the securing handle 20. The second way to accommodate varying axle diameters is to add shims or volume fillers between the compression surface 21 and the axle groove 13.

It should be noted that variations of the preferred embodiment, which still contain the basic principles or structures of the invention, are acknowledged. It is not practical to describe all variations of the through-axle bicycle fork mounting clamp. The disclosed invention is not limited to the details of the preferred embodiment.

The invention claimed is:

1. A through-axle bicycle fork mounting clamp for fork mounting a bicycle to a vehicle rack or a storage rack, comprising:
(a) a clamp body which includes an axle groove that is substantially semi-cylindrical to receive a bicycle axle;
(b) a securing handle which includes or activates a compression surface that holds said bicycle axle in said axle groove; and
(c) means of adjoining said clamp body to said vehicle rack.

2. Claim 1 where said bicycle axle is a substitute or replacement axle.

3. Claim 1 where said axle groove or said compression surface has been modified to accept a different axle diameter.

4. Claim 1 where said means for adjoining said clamp body to said vehicle rack utilize a rack screw to compress a structural member of said vehicle rack between a threaded retaining block and said clamp body.

5. Claim 4 where the said structural member is compressed between said threaded retaining block and a retaining ledge of said clamp body.

6. Claim 4 where said rack screw further comprises a rack screw knob contained substantially within said clamp body.

7. Claim 6 further comprising at least one link, connected between said clamp body and said securing handle.

8. Claim 1 where said means for adjoining said clamp body to said vehicle rack is structurally integrated into said vehicle rack.

9. Claim 1 where said clamp body further includes an anti-theft lock hole that receives a lock to prevent theft.

10. Claim 1 where said axle groove is disposed to contact the bottom circumference of said axle.

11. Claim 1 where said compression surface of said securing handle is disposed to contact the top circumference of said bicycle axle.

12. Claim 1 where said compression surface is activated by the securing handle through a linkage, screw, or cam.

13. A method of fork mounting the front fork of a bicycle to a through-axle bicycle fork mounting clamp, which is attached to a vehicle rack or storage rack, comprising:
(a) removing said bicycle's front wheel and front axle from said front fork;
(b) re-installing only said front axle onto said front fork;
(c) placing said front axle into an axle groove;
(d) closing a securing handle which contains or activates a compression surface; and
(e) connecting the back wheel to said vehicle rack.

14. The method of claim 13, where said bicycle's said front fork has axle pass-through openings.

15. The method of claim 13 where said bicycle's said front axle has a diameter greater than nine millimeters.

16. The method of claim 13 wherein removing step (a), and reinstalling step (b) are performed with said bicycle at ground level.

17. The method of claim 13 wherein closing step (d) simultaneously prevents the rack screw knob from turning.

18. The method of claim 13 further comprising:
(f) placing a lock through the anti-theft lock hole.

19. The method of claim 13 where a replacement axle is used for re-installing step (b).

20. The method of claim 13 where the shape of said axle groove is modified to accept a different axle diameter.

21. The method of claim 13 where the shape of said compression surface is modified to accept a different axle diameter.

22. An integrated through-axle bicycle rack for fork mounting a bicycle comprising:
a vehicle rack; and
a through-axle bicycle fork mounting clamp.

23. A mechanism for attaching a through-axle bicycle fork mounting clamp to a vehicle rack comprising:
a retaining block;
a retaining ledge;
a rack screw; and
a rack screw knob.

24. Claim 23 where a structural member of said vehicle rack is compressed between said retaining block and said retaining ledge.

25. Claim 23 where said retaining ledge is an integral structure of said through-axle bicycle fork mounting clamp.
